(19) United States
(12) Patent Application Publication
(10) Pub. No.: US 2009/0014452 A1
(43) Pub. Date: Jan. 15, 2009

(54) STORAGE TANK

(75) Inventor: Wilhelm SCHUHBECK, Stein (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 12/169,832

(22) Filed: Jul. 9, 2008

(30) Foreign Application Priority Data
Jul. 10, 2007 (DE) 10 2007 032 020.7

(51) Int. Cl. F17C 1/02

(52) U.S. Cl. 220/560.12; 220/565

(57) ABSTRACT

A storage tank including an outer tank, one or more inner tanks arranged inside the outer tank, and supply and discharge lines in the inner tank(s) is disclosed. The, or at least one of the, inner tanks is comprised at least in part of a carbon fiber and/or a carbon fiber reinforced material and/or is reinforced with a carbon fiber and/or a carbon fiber reinforced material.

This application claims the priority of German Patent Document No. 10 2007 032 020.7, filed Jul. 10, 2007, the disclosure of which is expressly incorporated by reference herein.

### BACKGROUND AND SUMMARY OF THE INVENTION

The invention relates to a storage tank comprised of an outer tank, one or more inner tanks arranged inside the outer tank, and supply and discharge lines in the inner tank(s).

Generic storage tanks are used to store the most varied of media, in particular, however, to store what are commonly known as cryogenic liquids, such as hydrogen for example. If these types of storage tanks are used for the storage of cryogenic liquids or liquefied gases, such as liquid nitrogen or liquid oxygen for example, the space between the outer and the inner tank(s) is provided with a corresponding vacuum (supra) insulation.

The inner tanks of these sorts of storage tanks are fabricated as a rule completely of steel, preferred of CrNi steel. The inner tanks are made as a rule of two dished bases as well as one or more cylinder sheets forming the cylindrical portion of the inner tank. The bases are connected or welded to the cylinder sheets as well as the cylinder sheets among one another by means of circumferential and longitudinal seams.

The objective of the present invention is disclosing a generic storage tank in which the use of the previous material of chromium nickel steel is reduced and that can also be manufactured more simply as well as more cost-effectively.

In order to attain this objective, a storage tank comprised of an outer tank, one or more inner tanks arranged inside the outer tank, and supply and discharge lines in the inner tank(s) is provided, which is characterized in that the or at least one of the inner tanks is comprised at least in part of a carbon fiber and/or a carbon fiber reinforced material and/or is reinforced with a carbon fiber and/or a carbon fiber reinforced material.

The term “carbon fiber reinforced material” should be understood as all materials having a carbon fiber.

Because of the at least partial use of a carbon fiber and/or a carbon fiber reinforced material for the inner tank(s), the use of steel, particularly of CrNi steel can be dispensed with in its entirety or at least in part. A reduction in quantity of the steel required for manufacturing an inner tank can also be realized in cases where the inner tanks are reinforced with a carbon fiber and/or a carbon fiber reinforced material.

The invention leads to a reduction in the dependence on steel as well as on the rising prices thereof. In addition, it renders possible a general savings in costs since in the meantime the carbon fiber materials or the carbon fiber reinforced materials can be manufactured more cheaply than steel, particularly CrNi steel. Especially in terms of transportable storage tanks, the savings in weight that is achieved with the realization of the invention is of great importance. Ultimately, the invention also makes it possible to save resources.

Additional advantageous embodiments of the inventive storage tank are characterized in that:
the supply and discharge line(s) is/are made at least in part of a carbon fiber and/or a carbon fiber reinforced material and/or is/are reinforced with a carbon fiber and/or a carbon fiber reinforced material;
the or at least one of the inner tanks is made completely of a carbon fiber and/or a carbon fiber reinforced material and/or is reinforced with a carbon fiber and/or a carbon fiber reinforced material;
solely the cylindrical region of the or at least one of the inner tanks is made completely of a carbon fiber and/or a carbon fiber reinforced material and/or is reinforced with a carbon fiber and/or a carbon fiber reinforced material;
tank sections are reinforced with carbon fiber and/or a carbon fiber reinforced material;
force application points, such as those that are used to fasten the inner tank, for example, are reinforced with carbon fiber and/or a carbon fiber reinforced material;
the means for fastening the inner tank(s), in this case suspension bands in particular, are made of carbon fiber and/or a carbon fiber reinforced material; and
if the or at least one of the inner tanks has a CrNi steel core, the wall thickness of an inner tank made of carbon fiber and/or a carbon fiber reinforced material is designed to be uniformly thick regardless of pressure as a function of the design pressure and the wall thickness of the CrNi steel core.

The inventive storage tank and additional embodiments of the same are explained in greater detail in the following on the basis of the exemplary embodiments depicted in the figures.

### BRIEF DESCRIPTION OF THE DRAWINGS

FIG. 1 illustrates a first embodiment of a storage tank of the present invention.

FIG. 2 illustrates a second embodiment of a storage tank of the present invention.

### DETAILED DESCRIPTION OF THE DRAWINGS

In this case, the two figures show a lateral sectional representation through two possible embodiments of the inventive storage tank. These embodiments are merely shown in schematic form, which is the reason why a representation of the required supply and discharge lines in the inner tank has been dispensed with. In addition, only the respective inner tank of the inventive storage tank is shown. The depiction of the outer tank as well as the insulation to be provided, as the case may be, is likewise dispensed with since its structure is sufficiently known to those skilled in the art.

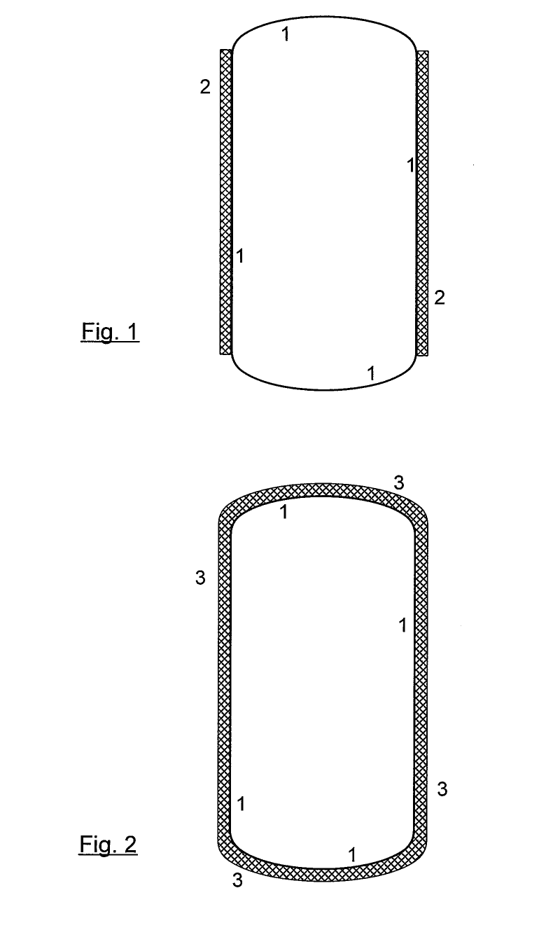

FIG. 1 depicts an inner tank 1, which is fabricated of a steel, preferably of CrNi steel. According to the invention, the cylindrical area of the inner tank 1 is henceforth surrounded by a carbon fiber material or a carbon fiber reinforcement 2. By using this design, the wall thickness in the cylindrical area of the inner tank 1 can be substantially reduced, for example, by one half of the original wall thickness. A design of this type is able to absorb the axial forces occurring within the inner tank 1 in a sufficient manner.

In terms of the inner tank design depicted in FIG. 2, the inner tank 1 itself is fabricated merely of a thin sheet. This reliably guarantees permanent leak-tightness of the inner tank 1. In addition, according to the invention, the inner tank 1 is completely surrounded by a carbon fiber material or a carbon fiber reinforcement 3. The thickness of the sheet used for the inner tank 1 can henceforth be considerably reduced as compared to a conventional inner tank manufactured of CrNi steel.

A further embodiment of the inventive storage tank can be realized in that the inner tank is made solely of a carbon fiber and/or a carbon fiber reinforced material. In this case, it is possible to dispense with an additional tank made of a steel material or a thin sheet.

According to a further advantageous embodiment of the inventive storage tank, the supply and discharge lines, which are not shown in FIGS. 1 and 2, can also be made at least in part of a carbon fiber and/or a carbon fiber reinforced material and/or be reinforced with a carbon fiber and/or a carbon fiber reinforced material.

Also not shown in FIGS. 1 and 2 are means to fasten the inner tank in the outer tank. These means are advantageously designed in such a way that the heat yield on the inner tank as well as the medium located therein can be minimized. Bands on which the inner tank is suspended are generally used for this. It is provided as a further development of the inventive storage tank that these suspensions or bands be made of carbon fiber and/or a carbon fiber reinforced material.

In addition to the embodiments of the inventive storage tank described in the figures as well as in the foregoing, a plurality of additional, alternative inner tank designs can be realized that make use of the inventive idea. Thus, for example, hybrid forms can be realized, in which the dished bases are made solely of a carbon fiber and/or a carbon fiber reinforced material, while the cylindrical area of the inner tank is reinforced with a carbon fiber and/or a carbon fiber reinforced material.

In addition, it is emphasized that the inventive idea can find application not only in the case of inner tank designs, such as those shown in the figures, but as a matter of principle in the case of all conceivable types of inner tank designs.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A storage tank comprised of an outer tank, one or more inner tanks arranged inside the outer tank, and supply and discharge lines in the inner tank(s), wherein the, or at least one of the, inner tanks is comprised at least in part of a carbon fiber and/or a carbon fiber reinforced material and/or is reinforced with a carbon fiber and/or a carbon fiber reinforced material.

2. The storage tank according to claim 1, wherein the supply and/or discharge line is/are made at least in part of a carbon fiber and/or a carbon fiber reinforced material and/or is/are reinforced with a carbon fiber and/or a carbon fiber reinforced material.

3. The storage tank according to claim 1, wherein the, or at least one of the, inner tanks are/is made completely of the carbon fiber and/or the carbon fiber reinforced material and/or is reinforced with the carbon fiber and/or the carbon fiber reinforced material.

4. The storage tank according to claim 1, wherein solely a cylindrical region of the, or at least one of the, inner tanks is made completely of the carbon fiber and/or the carbon fiber reinforced material and/or is reinforced with the carbon fiber and/or the carbon fiber reinforced material.

5. The storage tank according to claim 1, wherein tank sections of the, or at least one of the, inner tanks are reinforced with the carbon fiber and/or the carbon fiber reinforced material.

6. The storage tank according to claim 1, wherein force application points for fastening the, or at least one of the, inner tanks to the outer tank are reinforced with the carbon fiber and/or the carbon fiber reinforced material.

7. The storage tank according to claim 1, wherein means for fastening the, or at least one of the, inner tanks are made of the carbon fiber and/or the carbon fiber reinforced material.

8. The storage tank according to claim 1, wherein at least one inner tank has a CrNi steel core, and wherein a wall thickness of an inner tank made of the carbon fiber and/or the carbon fiber reinforced material is designed to be uniformly thick regardless of pressure as a function of a design pressure and a wall thickness of the CrNi steel core.

9. A cryogenic liquid storage tank, comprising:
an outer tank;
an inner tank disposed inside the outer tank;
vacuum insulation disposed between the outer tank and the inner tank; and
a cryogenic liquid stored inside of the inner tank;
wherein the inner tank is comprised at least in part of a carbon fiber and/or a carbon fiber reinforced material and/or is reinforced with a carbon fiber and/or a carbon fiber reinforced material.

10. The cryogenic liquid storage tank according to claim 9, wherein the inner tank includes a thin sheet and wherein the thin sheet is surrounded by the carbon fiber and/or the carbon fiber reinforced material.
